(19) United States
(12) Patent Application Publication
(10) Pub. No.: US 2022/0279855 A1
(43) Pub. Date: Sep. 8, 2022

(54) ELECTRONIC ATOMIZATION DEVICE, ATOMIZATION CORE AND PREPARATION METHOD THEREFOR

(71) Applicant: SHENZHEN SMOORE TECHNOLOGY LIMITED, Shenzhen (CN)

(72) Inventors: Hongming ZHOU, Shenzhen (CN); Dongfu JIANG, Shenzhen (CN); Zhenqian CHENG, Shenzhen (CN); Feng CHEN, Shenzhen (CN)

(21) Appl. No.: 17/826,513

(22) Filed: May 27, 2022

Related U.S. Application Data
(63) Continuation of application No. PCT/CN2020/122524, filed on Oct. 21, 2020.

(30) Foreign Application Priority Data
Dec. 2, 2019 (CN) 201911214936.3

(51) Int. Cl. A24F 40/46; A24F 40/70; A24F 40/10; C04B 37/00

(52) U.S. Cl. CPC A24F 40/46; A24F 40/70; A24F 40/10; C04B 37/001; C04B 2237/348; C04B 2237/341; C04B 2237/343

(57) ABSTRACT

A vaporization core of an electronic vaporization device includes: a porous ceramic substrate; a ceramic covering layer; and a heating film. The ceramic covering layer is combined on a surface of the porous ceramic substrate. The heating film is combined on a surface of the ceramic covering layer away from the porous ceramic substrate. A porosity of the ceramic covering layer is lower than a porosity of the porous ceramic substrate. A plurality of penetrating holes are formed on the ceramic covering layer.

### CROSS-REFERENCE TO PRIOR APPLICATION

This application is a continuation of International Patent Application No. PCT/CN2020/122524, filed on Oct. 21, 2020, which claims priority to CN 201911214936.3, filed on Dec. 2, 2019. The entire disclosure of both applications is hereby incorporated by reference herein.

### FIELD

The present invention relates to the field of electronic cigarette technologies, and specifically, to an electronic vaporization device, and a vaporization core and a manufacturing method thereof.

### BACKGROUND

An electronic cigarette looks and tastes like a cigarette, but generally does not include harmful ingredients such as tar and aerosols in the cigarette, thereby greatly reducing harm to a user's body. Therefore, the electronic cigarette is generally used as an alternative of the cigarette for smoking cessation. The safety of the electronic cigarette is the primary factor to be considered.

Currently, in an inhaling process, a vaporization core of the electronic cigarette inevitably has a risk of powder falling due to repeated thermal cycling and e-liquid erosion. In addition, in a high temperature environment, heavy metal inside the vaporization core and heavy metal inside a heating film may enter airflow during inhaling, causing a potential safety hazard to users' health.

### SUMMARY

In an embodiment, the invention provides a vaporization core of an electronic vaporization device, comprising: a porous ceramic substrate; a ceramic covering layer; and a heating film, wherein the ceramic covering layer is combined on a surface of the porous ceramic substrate, wherein the heating film is combined on a surface of the ceramic covering layer away from the porous ceramic substrate, wherein a porosity of the ceramic covering layer is lower than a porosity of the porous ceramic substrate, and wherein a plurality of penetrating holes are formed on the ceramic covering layer.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic diagram of a cross-sectional structure of a vaporization core according to an embodiment of the present invention;

FIG. 2 is a schematic diagram of a cross-sectional structure of the vaporization core in FIG. 1 taken along an I-I direction;

FIG. 3 is a partial enlarged view of a cross-sectional structure of a vaporization core according to another embodiment of the present invention;

FIG. 4 is a schematic flowchart of a manufacturing method of a vaporization core according to an embodiment of the present invention;

FIG. 5 is a schematic flowchart of processing corresponding to the manufacturing process in FIG. 4;

FIG. 6 is a schematic flowchart of step S105 in FIG. 4;

FIG. 7 is a schematic flowchart of a manufacturing method of a vaporization core according to another embodiment of the present invention; and

FIG. 8 is a schematic flowchart of processing corresponding to the manufacturing process in FIG. 7.

### DETAILED DESCRIPTION

In an embodiment, the present invention provides an electronic vaporization device, and a vaporization core and a manufacturing method thereof, to resolve the technical problems of powder falling and heavy metal precipitation of the vaporization core in the related art.

In an embodiment, the invention provides a vaporization core of an electronic vaporization device, including: a porous ceramic substrate, a ceramic covering layer, and a heating film, where the ceramic covering layer is combined on a surface of the porous ceramic substrate, the heating film is combined on a surface of the ceramic covering layer away from the porous ceramic substrate, a porosity of the ceramic covering layer is lower than a porosity of the porous ceramic substrate, and a plurality of penetrating holes are formed on the ceramic covering layer.

Optionally, the porosity of the porous ceramic substrate is 40% to 80%; an average pore size of micropores on the porous ceramic substrate is 10 μm to 40 μm; a material for forming the porous ceramic substrate is zirconium oxide, silicon oxide, aluminum oxide, or mullite; and/or a thickness of the porous ceramic substrate is 1 mm to 4 mm.

Optionally, the porosity of the ceramic covering layer is 10% to 20%; a material for forming the ceramic covering layer is zirconium oxide, silicon oxide, aluminum oxide, silicon carbide, or mullite; a thickness of the ceramic covering layer is 0.05 mm to 0.2 mm; and/or a powder size of the material for forming the ceramic covering layer is 0.1 μm to 5 μm.

Optionally, a diameter of each hole is 5 μm to 50 μm.

Optionally, a ratio of a total opening area of the plurality of holes to an area of a cross section of the ceramic covering layer perpendicular to an extending direction of the holes is 5% to 15%.

Optionally, a powder size of the material for forming the ceramic covering layer is 0.1 μm to 5 μm.

Optionally, the heating film is made of metal or alloy; and/or a thickness of the heating film is 2 μm to 10 μm.

Optionally, the heating film includes a first covering film and a second covering film, where the first covering film is stacked on the surface of the ceramic covering layer away from the porous ceramic substrate, and the second covering film is stacked on a surface of the first covering film away from the ceramic covering layer.

Optionally, the first covering film and the second covering film are metal or alloy.

To resolve the foregoing technical problems, another technical solution of the present invention is to provide a manufacturing method of a vaporization core of an electronic vaporization device, including: manufacturing a porous ceramic substrate; manufacturing a ceramic covering layer, and forming a plurality of holes penetrating the ceramic covering layer on the ceramic covering layer, where a porosity of the ceramic covering layer is lower than a porosity of the porous ceramic substrate; stacking the porous ceramic substrate and the ceramic covering layer to form an integral structure; forming a heating film on a surface of the ceramic covering layer away from the porous ceramic substrate.

Optionally, the step of manufacturing a porous ceramic substrate includes: manufacturing a raw material for forming the porous ceramic substrate into a first casting slurry; and manufacturing the porous ceramic substrate through a casting process, where a thickness of the porous ceramic substrate is 1 mm to 4 mm.

Optionally, the step of manufacturing a ceramic covering layer includes: manufacturing a raw material for forming the ceramic covering layer into a second casting slurry, where a powder size of the material for forming the ceramic covering layer is 0.1 μm to 5 μm; and manufacturing the ceramic covering layer through a casting process or a dry pressing process, where a thickness of the ceramic covering layer is 0.05 mm to 0.2 mm.

Optionally, the step of stacking the porous ceramic substrate and the ceramic covering layer to form an integral structure includes: connecting the porous ceramic substrate to the ceramic covering layer through bonding or sintering.

Optionally, the step of forming a heating film on a surface of the ceramic covering layer away from the porous ceramic substrate includes: forming the heating film on the surface of the ceramic covering layer away from the porous ceramic substrate through physical vapor deposition (PVD), chemical vapor deposition (CVD), electroplating, electrodeposition, ion plating, or coating, where a thickness of the heating film is 2 μm to 10 μm.

Optionally, the step of forming a heating film on a surface of the ceramic covering layer away from the porous ceramic substrate includes: forming a first covering film on the surface of the ceramic covering layer away from the porous ceramic substrate through PVD, CVD, electroplating, electrodeposition, ion plating, or coating; and forming a second covering film on a surface of the first covering film away from the ceramic covering layer through PVD, CVD, electroplating, electrodeposition, ion plating, or coating, where the first covering film and the second covering film form the heating film.

Optionally, the first covering film and the second covering film are metal or alloy.

To resolve the foregoing technical problems, another technical solution of the present invention is to provide an electronic vaporization device, including a liquid storage cavity configured to store e-liquid and the vaporization core as described above, where the e-liquid in the liquid storage cavity is capable of being transmitted to the ceramic covering layer through the porous ceramic substrate.

Beneficial effects of the present invention are as follows: different from the related art, in the embodiments of the present invention, a ceramic covering layer whose porosity is lower than that of a porous ceramic substrate is combined on a surface, which is close to a heating component, of the porous ceramic substrate, so that powder falling of the vaporization core can be avoided because the ceramic covering layer with a lower porosity has a higher density and prevents power falling. In addition, the ceramic covering layer with a lower porosity can isolate precipitation of heavy metal inside the porous ceramic substrate, so that the heavy metal may be prevented from entering airflow during inhaling, thereby improving safety performance of the electronic vaporization device.

The technical solutions in the embodiments of the utility model are clearly and completely described below with reference to the accompanying drawings in the embodiments of the utility model. Apparently, the described embodiments are merely some but not all of the embodiments of the utility model. All other embodiments obtained by a person of ordinary skill in the art based on the embodiments of the utility model without creative efforts shall fall within the protection scope of the utility model.

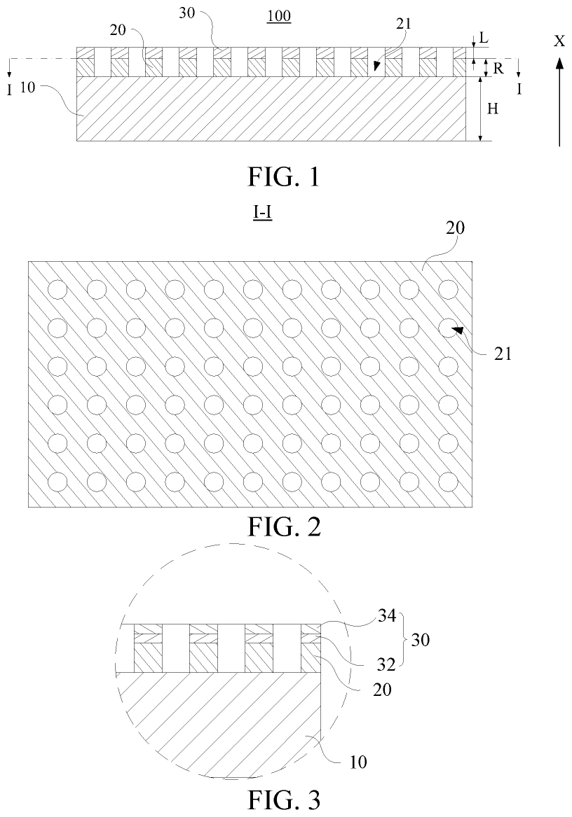

Referring to FIG. 1, FIG. 1 is a schematic diagram of a cross-sectional structure of a vaporization core according to an embodiment of the present invention. The utility model provides a vaporization core 100 of an electronic vaporization device, and the vaporization core 100 includes a porous ceramic substrate 10, a ceramic covering layer 20, and a heating film 30. The ceramic covering layer 20 is combined on a surface of the porous ceramic substrate 10, the heating film 30 is combined on a surface of the ceramic covering layer 20 away from the porous ceramic substrate 10, a porosity of the ceramic covering layer 20 is lower than a porosity of the porous ceramic substrate 10, and a plurality of penetrating holes 21 are formed on the ceramic covering layer 20.

The porosity refers to a ratio of a total volume of micropores in a porous medium to a total volume of the porous medium. The ceramic covering layer 20 being combined on a surface of the porous ceramic substrate 10 means that, the ceramic covering layer 20 is combined on a surface, which is close to a heating component, of the porous ceramic substrate 10, to prevent the porous ceramic substrate 10 from being in direct contact with the heating component. As shown in FIG. 1, in this embodiment, the ceramic covering layer 20 is combined on an upper surface of the porous ceramic substrate 10.

In the embodiments of the utility model, a ceramic covering layer 20 whose porosity is lower than that of a porous ceramic substrate 10 is combined on a surface, which is close to a heating component, of the porous ceramic substrate 10, so that powder falling of the vaporization core can be avoided because the ceramic covering layer 20 with a lower porosity has a higher density and prevents power falling. In addition, the ceramic covering layer 20 with a lower porosity can isolate precipitation of heavy metal inside the porous ceramic substrate 10, so that the heavy metal can be prevented from entering airflow during inhaling, thereby improving safety performance of the electronic vaporization device.

Optionally, a material for forming the porous ceramic substrate 10 may be zirconium oxide, silicon oxide, aluminum oxide, or mullite, and a material for forming the ceramic covering layer 20 may be zirconium oxide, silicon oxide, aluminum oxide, silicon carbide, or mullite, where the material of the porous ceramic substrate 10 and the material of the ceramic covering layer 20 may be of the same or different types, and the types of the material of the porous ceramic substrate 10 and the material of the ceramic covering layer 20 are not limited in the embodiments of the utility model.

Optionally, the porosity of the porous ceramic substrate 10 may be 40% to 80%. A value of the porosity may be adjusted according to components of e-liquid. For example, when the e-liquid has relatively high viscosity, a relatively high porosity is selected to ensure a liquid guiding effect.

In this embodiment, the porosity of the porous ceramic substrate 10 is 50% to 60%. By controlling the porosity of the porous ceramic substrate 10 to be within 50% to 60%, on one hand, good liquid guiding efficiency of the porous ceramic substrate 10 is ensured, and dry burning caused by poor circulation of the e-liquid can be prevented, thereby improving a vaporization effect. On the other hand, the porous ceramic substrate 10 can be prevented from guiding liquid at an excessively high speed, to avoid a large increase in a liquid leakage probability caused by difficulty in liquid locking.

Optionally, an average pore size of micropores on the porous ceramic substrate 10 is 10 μm to 40 μm. For example, the average pore size may be 10 μm, 15 μm, 20 μm, 25 μm, 30 μm, 35 μm, or 40 μm, which is not specifically limited in the embodiments of the utility model.

According to the foregoing optional embodiments, by setting pore sizes of the micropores with suitable sizes and uniform distribution, liquid guiding of the porous ceramic substrate 10 may be uniform, thereby achieving a better vaporization effect.

Optionally, a thickness of the porous ceramic substrate 10 is 1 mm to 4 mm. The thickness of the porous ceramic substrate 10 refers to a length of the porous ceramic substrate 10 in a stacking direction of the porous ceramic substrate 10 and the ceramic covering layer 20. In this embodiment, the stacking direction of the porous ceramic substrate 10 and the ceramic covering layer 20 is a direction X shown in FIG. 1, and a thickness H of the porous ceramic substrate 10 in the direction X is 1 mm to 4 mm. The use of the porous ceramic substrate 10 with a suitable thickness can shorten a liquid guiding path, to make liquid transmission smooth. On the other hand, dry burning can be also prevented.

Optionally, the thickness H of the porous ceramic substrate 10 in the direction X may be 1 mm, 1.5 mm, 2 mm, 2.5 mm, 3 mm, 3.5 mm, or 4 mm, which is not specifically limited in the embodiments of the utility model.

Optionally, the porosity of the ceramic covering layer 20 is 10% to 20%. In the same vaporization core 100, the porosity of the ceramic covering layer 20 is lower than the porosity of the porous ceramic substrate 10, so that a dense ceramic covering layer 20 is formed on the surface of the porous ceramic substrate 10. In an embodiment, the porosity of the ceramic covering layer 20 may be 10% to 18%, 10% to 16%, 10% to 14%, 10% to 12%, 12% to 18%, 12% to 16%, 12% to 14%, 14% to 16%, 14% to 18%, or 16% to 18%. In another embodiment, the porosity of the porous ceramic substrate 10 is 50% to 60%, and the porosity of the ceramic covering layer 20 is 14% to 16%.

Optionally, a thickness of the ceramic covering layer 20 is 0.05 mm to 0.2 mm. The thickness of the ceramic covering layer 20 refers to a length of the ceramic covering layer 20 in the stacking direction of the porous ceramic substrate 10 and the ceramic covering layer 20. In this embodiment, the stacking direction of the porous ceramic substrate 10 and the ceramic covering layer 20 is the direction X shown in FIG. 1, and a thickness R of the ceramic covering layer 20 in the direction X is 0.05 mm to 0.2 mm. For example, the thickness R of the ceramic covering layer 20 in the direction X may be 0.05 mm, 0.07 mm, 0.09 mm, 0.11 mm, 0.13 mm, 0.15 mm, 0.17 mm, or 0.2 mm, which is not specifically limited in the embodiments of the utility model.

Optionally, a powder size of the material for forming the ceramic covering layer 20 is 0.1 μm to 5 μm. The powder size is also referred to as a particle size, which refers to a size of a space occupied by a particle. For a spherical particle, the powder size is a single parameter, namely, a diameter D. For a particle in an irregular shape, the powder size may be expressed by using a projection height H (any), a maximum length M, a horizontal width W, a diameter of a sphere with the same volume, or a diameter D of a sphere with the same surface area.

Optionally, the powder size of the material for forming the ceramic covering layer 20 may be 0.1 μm, 0.5 μm, 1 μm, 1.5 μm, 2 μm, 2.5 μm, 3 μm, 3.5 μm, or 4 μm, which is not specifically limited in the embodiments of the utility model.

According to the foregoing optional embodiments, by setting the ceramic covering layer 20 with a suitable thickness, pore sizes of micropores with suitable sizes and uniform distribution, and a raw material with a relatively small powder size, the ceramic covering layer 20 can effectively isolate precipitation of heavy metal.

Further, as shown in FIG. 1 and FIG. 2, FIG. 2 is a schematic diagram of a cross- sectional structure of the vaporization core in FIG. 1 taken along an I-I direction. A diameter of each hole 21 formed on the ceramic covering layer 20 is 5 μm to 50 μm. For example, the diameter of the hole 21 may be 5 μm, 10 μm, 15 μm, 20 μm, 25 μm, 30 μm, 35 μm, 40 μm, 45 μm, or 50 μm, which is not specifically limited in the embodiments of the utility model. It should be noted that, the holes 21 on the ceramic covering layer 20 are not the micropores in the porous medium, and the existence of the holes 21 does not affect the porosity of the ceramic covering layer 20. In other words, the porosity of the ceramic covering layer 20 is irrelevant to the plurality of holes 21 formed on the ceramic covering layer 20.

Specifically, the plurality of holes 21 are formed on the ceramic covering layer 20, and each hole 21 penetrates the ceramic covering layer 20 in the stacking direction of the porous ceramic substrate 10 and the ceramic covering layer 20. Forming the plurality of penetrating holes 21 on the ceramic covering layer 20 may facilitate liquid guiding of the ceramic covering layer 20.

Optionally, diameters of the plurality of holes 21 formed on the same ceramic covering layer 20 may be the same or may be different, which is not specifically limited in the embodiments of the utility model.

In this embodiment, as shown in FIG. 2, the plurality of holes 21 are arranged on the ceramic covering layer 20 in an array. In another embodiment, the plurality of holes 21 may be alternatively distributed annularly, and an arrangement manner of the plurality of holes 21 is not specifically limited in the embodiments of the utility model.

Optionally, in this embodiment, the hole 21 formed on the ceramic covering layer 20 is a circular hole. In other embodiments, the shape of the hole 21 may alternatively be a rectangle, an ellipse, a triangle, a diamond, or a regular or irregular polygon, which is not specifically limited in the embodiments of the utility model.

Further, a ratio of a total opening area of the plurality of holes 21 to an area of a cross section of the ceramic covering layer 20 perpendicular to an extending direction of the holes 21 is 5% to 15%. For example, the ratio of the total opening area of the plurality of holes 21 to the area of the cross section of the ceramic covering layer 20 perpendicular to the extending direction of the holes 21 may be 5% to 12%, 5% to 10%, 5% to 8%, 7% to 12%, 7% to 10%, 9% to 12%, 10% to 12%, 7% to 15%, 9% to 15%, 12% to 15%, or 14% to 15%, which is not specifically limited in the embodiments of the utility model.

Specifically, in this embodiment, as shown in FIG. 1, the extending direction of the holes 21 is an axial direction of the circular holes, and the axial direction of the circular holes is parallel to the direction X. Therefore, the cross section of the ceramic covering layer 20 perpendicular to the extending direction of the holes 21 is a cross section of the ceramic covering layer 20 perpendicular to the direction X, namely, the cross section shown in FIG. 2. The total opening area of the plurality of holes 21 refers to areas of blank regions shown in the figure, and the ratio of the total opening area of the plurality of holes 21 to the area of the cross section of the ceramic covering layer 20 perpendicular to the extending direction of the holes 21 refers to a ratio of the areas of the blank regions in FIG. 2 to an area of the entire cross section.

Further, as shown in FIG. 1, the heating film 30 is combined on the surface of the ceramic covering layer 20 away from the porous ceramic substrate 10, and the heating film 30 is configured to be electrically connected to an electrode and produce heat to vaporize the e-liquid.

Optionally, a thickness of the heating film 30 may be 2 μm to 10 μm. The thickness of the heating film 30 refers to a length of the heating film 30 in the stacking direction of the porous ceramic substrate 10 and the ceramic covering layer 20. As shown in FIG. 1, the thickness of the heating film 30 is L, and the thickness L may be specifically 2 μm, 3 μm, 4 μm, 5 μm, 6 μm, 7 μm, 8 μm, 9 μm, 9.5 μm, or 10 μm, which is not specifically limited in the embodiments of the utility model.

Optionally, as shown in FIG. 3, FIG. 3 is a partial enlarged view of a cross-sectional structure of a vaporization core according to another embodiment of the utility model. The heating film 30 may include a first covering film 32 and a second covering film 34. The first covering film 32 is stacked on the surface of the ceramic covering layer 20 away from the porous ceramic substrate 10, and the second covering film 34 is stacked on a surface of the first covering film 32 away from the ceramic covering layer 20.

The first covering film 32 may be metal or alloy. To increase the bonding force between the first covering film 32 and the porous ceramic substrate 10, the first covering film 32 may be made of a material that can be stably bound to the porous ceramic substrate 10. For example, the first covering film 32 may be titanium, zirconium, titanium-aluminum alloy, titanium-zirconium alloy, titanium-molybdenum alloy, titanium-niobium alloy, iron- aluminum alloy, or tantalum-aluminum alloy.

A titanium-zirconium alloy film made of the titanium-zirconium alloy is a local dense film, but the porous ceramic substrate 10 is a porous structure. As a result, the titanium-zirconium alloy film formed on the surface of the porous ceramic substrate 10 also becomes a porous continuous structure, and pore size distribution of the titanium-zirconium alloy film is slightly smaller than pore sizes of the micropores on the surface of the porous ceramic substrate 10.

Further, the stability of titanium and zirconium in the titanium-zirconium alloy film is relatively poor under a high temperature in the air; zirconium may easily adsorb hydrogen, nitrogen, and oxygen; zirconium and titanium have enhanced gas adsorption after being alloyed. Therefore, when an electrode is manufactured subsequently, due to the gas adsorption of the titanium-zirconium alloy, during high temperature sintering (higher than 300° C.), intense oxidation reaction may occur, causing an abrupt change in the resistance of the first covering film 32. To prevent the first covering film 32 from being in contact with air, one protection layer needs to be made on a surface of the first covering film 32. The second covering film 34 may be used as the protection layer.

The second covering film 34 may be also metal or alloy. To prevent the first covering film 32 from being in contact with air and oxidized to cause an abrupt change in the resistance, the second covering film 34 should be made of a material with relatively strong anti-oxidation performance. For example, the second covering film 34 may be platinum, palladium, palladium-copper alloy, gold-silver-platinum alloy, gold-silver alloy, palladium-silver alloy, or gold-platinum alloy

A protection layer formed by silver or platinum is relatively loose and has a relatively low density, which can hardly isolate air completely. Gold can protect the titanium- zirconium alloy film well. However, to form a dense protection layer, a thickness of about 100 nm or larger is required, which may greatly reduce the resistance of the entire heating component; in addition, costs are high. Therefore, in this embodiment, the gold-silver alloy is used, so that the density of the gold protection layer is retained while the costs are reduced, and resistivity of the gold-silver alloy is increased by ten times after gold and silver are alloyed according to a specific ratio, which is more helpful to control the resistance of the entire heating component.

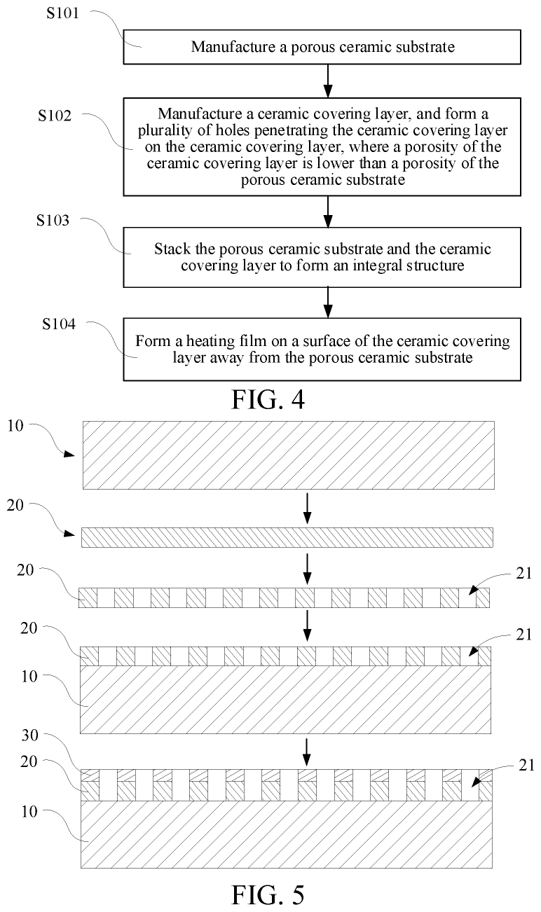

Further, the utility model further provides a manufacturing method of a vaporization core of an electronic vaporization device, and the vaporization core 100 in the foregoing embodiment may be formed by using the manufacturing method. As shown in FIG. 4 and FIG. 5, FIG. 4 is a schematic flowchart of a manufacturing method of a vaporization core according to an embodiment of the utility model, and FIG. 5 is a schematic flowchart of processing corresponding to the manufacturing process in FIG. 4. The manufacturing method of the vaporization core 100 includes the following steps:

Step S101: Manufacture a porous ceramic substrate 10.

First, a raw material for forming the porous ceramic substrate 10 is manufactured into a first casting slurry, where the raw material for forming the porous ceramic substrate 10 may be zirconium oxide, silicon oxide, aluminum oxide, or mullite, and at least one of the foregoing raw materials is mixed to form the first casting slurry.

The first casting slurry is then manufactured into the porous ceramic substrate 10 by using a casting process. In addition, a casting time may be controlled to cause a thickness of the porous ceramic substrate 10 to be 1 mm to 4 mm.

Step S102: Manufacture a ceramic covering layer 20, and form a plurality of holes penetrating the ceramic covering layer 20 on the ceramic covering layer 20, where a porosity of the ceramic covering layer 20 is lower than a porosity of the porous ceramic substrate 10.

First, a raw material for forming the ceramic covering layer 20 is manufactured into a second casting slurry. The material for forming the ceramic covering layer 20 may be zirconium oxide, silicon oxide, aluminum oxide, silicon carbide, or mullite, and a powder size of the material for forming the ceramic covering layer 20 is 0.1 μm to 5 μm. At least one of the foregoing raw materials is mixed to form the second casting slurry.

In an embodiment, the second casting slurry may be then manufactured into the ceramic covering layer 20 by using the casting process. In addition, a casting time may be controlled to cause a thickness of the ceramic covering layer 20 to be 0.05 mm to 0.2 mm.

Alternatively, in another embodiment, the second casting slurry may be manufactured into the ceramic covering layer 20 by using a dry pressing process, which is not specifically limited in the embodiments of the utility model.

After the ceramic covering layer 20 is manufactured, a plurality of holes penetrating the ceramic covering layer 20 need to be further formed on the ceramic covering layer 20. A diameter of each hole 21 is 5 μm to 50 μm, and a ratio of a total area of the plurality of holes 21 to an area of a cross section of the ceramic covering layer 20 perpendicular to an extending direction of the holes 21 is 5% to 15%.

Specifically, the plurality of holes 21 penetrating the ceramic covering layer 20 may be directly formed on the ceramic covering layer 20 through laser drilling, computerized numerical control (CNC) precision drilling, or selective corrosion drilling. By directly forming the through holes penetrating the ceramic covering layer 20 on the ceramic covering layer 20, the drilling manner is simple, and the holes 21 on the formed vaporization core 100 have relatively high depth consistency.

Optionally, diameters of the plurality of holes 21 formed on the same ceramic covering layer 20 may be the same or may be different. The shape of the hole 21 formed on the ceramic covering layer 20 may be a circle, a rectangle, an ellipse, a triangle, a diamond, or a regular or irregular polygon, which is not specifically limited in the embodiments of the utility model.

In the foregoing embodiment, the porous ceramic substrate 10 is first manufactured, and the ceramic covering layer 20 is then manufactured. It may be understood that, in another embodiment, the ceramic covering layer 20 may be first manufactured, and the porous ceramic substrate 10 is then manufactured. Alternatively, in still another embodiment, the ceramic covering layer 20 and the porous ceramic substrate 10 are manufactured at the same time, which is not specifically limited in the embodiments of the utility model.

After steps S101 and S102 are performed to obtain the porous ceramic substrate 10 and the ceramic covering layer 20, the following steps are performed:

Step 5103: Stack the porous ceramic substrate 10 and the ceramic covering layer 20 to form an integral structure.

Specifically, in an embodiment, the ceramic covering layer 20 may be stacked on one side of the porous ceramic substrate 10, and the ceramic covering layer 20 and the porous ceramic substrate 10 are connected and fixed through bonding.

In this embodiment, alternatively, the ceramic covering layer 20 may be stacked on one side of the porous ceramic substrate 10, and the porous ceramic substrate 10 and the ceramic covering layer 20 are connected through sintering.

The sintering refers to a process in which solid particles of a ceramic green body are mutually bonded at a high temperature (not higher than a melting point); as crystal grains grow, gaps (pores) and crystal grain boundaries are gradually decreased, and through mass transfer, a total volume of the ceramic green body shrinks and the density is increased; finally, the ceramic green body becomes a dense polycrystal sintered compact with a microscopic structure. In this embodiment, the ceramic covering layer 20 and the porous ceramic substrate 10 are connected through sintering, and no harmful material is generated, so that the safety performance of the vaporization core 100 can be improved.

Referring to FIG. 4 and FIG. 5, in this embodiment, after step S103 is performed to obtain the porous ceramic substrate 10 and the ceramic covering layer 20 that form an integral structure, the method further includes:

Step S104: Form a heating film 30 on a surface of the ceramic covering layer 20 away from the porous ceramic substrate 10.

A thickness of the heating film is 2 μm to 10 μm. Optionally, the heating film 30 may be formed on the ceramic covering layer 20 through physical vapor deposition (PVD), electroplating, electrodeposition, ion plating, coating, or chemical vapor deposition (CVD). A uniformly distributed heating film 30 with a relatively small thickness and a relatively large area may be formed in any of the foregoing manners, so that when the heating film 30 is electrically connected to an electrode, the heating film 30 generates heat uniformly and has a large heating area and high heat utilization. In addition, precipitation of heavy metal inside the vaporization core 100 may be greatly reduced, thereby further improving the safety performance.

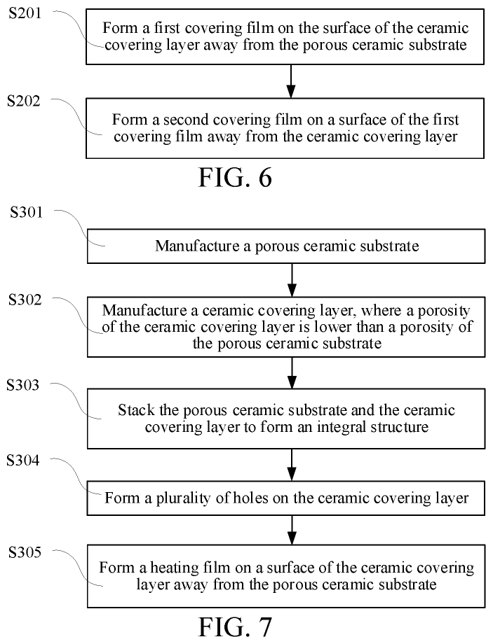

Optionally, in an embodiment, with reference to FIG. 3 and FIG. 6, FIG. 6 is a schematic flowchart of step S105 in FIG. 4. The step of forming a heating film 30 on a surface of the ceramic covering layer 20 away from the porous ceramic substrate 10 includes:

Step 5201: Form a first covering film 32 on the surface of the ceramic covering layer 20 away from the porous ceramic substrate 10.

The first covering film 32 may be metal or alloy. The first covering film 32 may be made of a material with relatively strong bonding force to the porous ceramic substrate 10. For example, the first covering film 32 may be titanium, zirconium, titanium-aluminum alloy, titanium-zirconium alloy, titanium-molybdenum alloy, titanium-niobium alloy, iron-aluminum alloy, or tantalum-aluminum alloy.

Step 5202: Form a second covering film 34 on a surface of the first covering film 32 away from the ceramic covering layer 20.

The second covering film 34 may be also metal or alloy. The second covering film 34 may be made of a material with relatively strong anti-oxidation performance. For example, the second covering film 34 may be platinum, palladium, palladium-copper alloy, gold-silver-platinum alloy, gold-silver alloy, palladium-silver alloy, or gold-platinum alloy

Optionally, the first covering film 32 and the second covering film 34 may be sequentially formed on the surface of the ceramic covering layer 20 away from the porous ceramic substrate 10 through PVD, CVD, electroplating, electrodeposition, ion plating, or coating. The first covering film 32 and the second covering film 34 that are formed in the foregoing manners have a relatively small thickness and a relatively large area, and are uniformly distributed, so that when the heating film 30 is electrically connected to an electrode, the heating film 30 generates heat uniformly, and has a large heating area and high heat utilization. In addition, inhaling of heavy metal inside the vaporization core 100 may be greatly reduced, thereby further improving the safety performance.

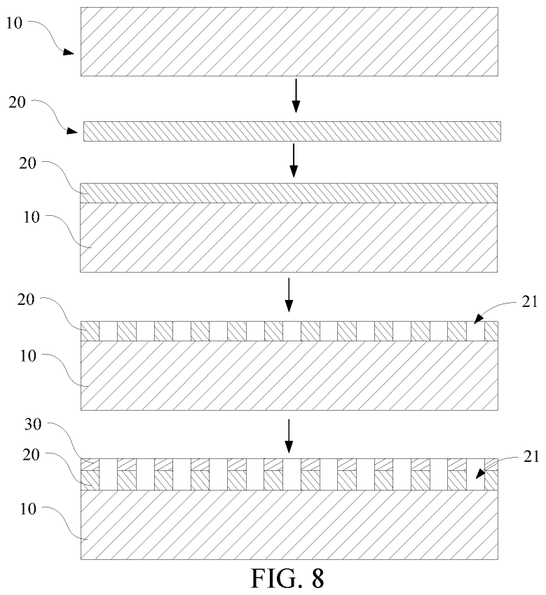

In another embodiment, referring to FIG. 7 and FIG. 8, FIG. 7 is a schematic flowchart of a manufacturing method of a vaporization core according to another embodiment of the utility model, and FIG. 8 is a schematic flowchart of processing corresponding to the manufacturing process in FIG. 7. The manufacturing method of the vaporization core 100 in this embodiment includes the following steps:

Step S301: Manufacture a porous ceramic substrate 10.

Step S302: Manufacture a ceramic covering layer 20, where a porosity of the ceramic covering layer 20 is lower than a porosity of the porous ceramic substrate 10.

Step S303: Stack the porous ceramic substrate 10 and the ceramic covering layer 20 to form an integral structure.

Step S304: Form a plurality of holes 21 on the ceramic covering layer 20.

Step S305: Form a heating film 30 on a surface of the ceramic covering layer 20 away from the porous ceramic substrate 10.

Step S301 is substantially the same as step S101 in the foregoing embodiment, step S303 is substantially the same as step S103 in the foregoing embodiment, and step S305 is substantially the same as step S104 in the foregoing embodiment. Refer to the description in the foregoing embodiment, and details are not described herein again. A difference between this embodiment and the foregoing embodiment lies in that, in this embodiment, the plurality of holes 21 on the ceramic covering layer 20 are not formed while the ceramic covering layer 20 is being manufactured, but are formed after the porous ceramic substrate 10 and the ceramic covering layer 20 are combined into an integral structure, and are formed through drilling on a side where the ceramic covering layer 20 is located.

In this embodiment, during drilling, first, it is necessary to set a depth of drilling to be equal to a thickness of the ceramic covering layer 20, and then drilling is performed on the side on which the ceramic covering layer 20 is located, to form a plurality of blind holes on the porous ceramic substrate 10 and the ceramic covering layer 20 that are combined into an integral structure. A drilling manner and a size of the hole are the same as those in the foregoing embodiment, and reference may be made to the description in the foregoing embodiment.

The utility model further provides an electronic vaporization device, including a liquid storage cavity configured to store e-liquid and a vaporization core, where the e-liquid in the liquid storage cavity is capable of being transmitted to a ceramic covering layer through a porous ceramic substrate.

A structure of the vaporization core in this embodiment is the same as the structure of the vaporization core in the foregoing embodiment. Refer to the description in the foregoing embodiment, and details are not described herein again.

Based on the above, a person skilled in the art may easily understand that, a ceramic covering layer 20 whose porosity is lower than that of a porous ceramic substrate 10 is combined on a surface, which is close to a heating component, of the porous ceramic substrate 10, so that powder falling of the vaporization core can be avoided because the ceramic covering layer 20 with a lower porosity has a higher density and prevents powder falling. In addition, the ceramic covering layer 20 with a lower porosity can isolate precipitation of heavy metal inside the porous ceramic substrate 10, so that the heavy metal can be prevented from entering airflow during inhaling, thereby improving safety performance of the electronic vaporization device.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A vaporization core of an electronic vaporization device, comprising:
a porous ceramic substrate;
a ceramic covering layer; and
a heating film,
wherein the ceramic covering layer is combined on a surface of the porous ceramic substrate,
wherein the heating film is combined on a surface of the ceramic covering layer away from the porous ceramic substrate,
wherein a porosity of the ceramic covering layer is lower than a porosity of the porous ceramic substrate, and
wherein a plurality of penetrating holes are formed on the ceramic covering layer.

2. The vaporization core of claim 1, wherein the porosity of the porous ceramic substrate is 40% to 80%, and/or
wherein an average pore size of micropores on the porous ceramic substrate is 10 μm to 40 μm, and/or
wherein a material for forming the porous ceramic substrate comprises zirconium oxide, silicon oxide, aluminum oxide, or mullite, and/or
wherein a thickness of the porous ceramic substrate is 1 mm to 4 mm.

3. The vaporization core of claim 1, wherein the porosity of the ceramic covering layer is 10% to 20%, and/or
wherein a material for forming the ceramic covering layer comprises zirconium oxide, silicon oxide, aluminum oxide, silicon carbide, or mullite, and/or
wherein a thickness of the ceramic covering layer is 0.05 mm to 0.2 mm, and/or
wherein a powder size of the material for forming the ceramic covering layer is 0.1 μm to 5 μm.

4. The vaporization core of claim 1, wherein a diameter of each hole of the plurality of penetrating holes is 5 μm to 50 μm.

5. The vaporization core of claim 4, wherein a ratio of a total opening area of the plurality of penetrating holes to an area of a cross section of the ceramic covering layer perpendicular to an extending direction of the plurality of penetrating holes is 5% to 15%.

6. The vaporization core of claim 1, wherein a powder size of a material for forming the ceramic covering layer is 0.1 μm to 5 μm.

7. The vaporization core of claim 1, wherein the heating film comprises metal or alloy, and/or wherein a thickness of the heating film is 2 μm to 10 μm.

8. The vaporization core of claim 1, wherein the heating film comprises a first covering film and a second covering film,
wherein the first covering film is stacked on the surface of the ceramic covering layer away from the porous ceramic substrate, and
wherein the second covering film is stacked on a surface of the first covering film away from the ceramic covering layer.

9. The vaporization core of claim 8, wherein the first covering film and the second covering film comprise metal or alloy.

10. A manufacturing method of a vaporization core of an electronic vaporization device, comprising:
manufacturing a porous ceramic substrate;
manufacturing a ceramic covering layer and forming a plurality of holes penetrating the ceramic covering layer on the ceramic covering layer, a porosity of the ceramic covering layer being lower than a porosity of the porous ceramic substrate;
stacking the porous ceramic substrate and the ceramic covering layer to form an integral structure; and
forming a heating film on a surface of the ceramic covering layer away from the porous ceramic substrate.

11. The manufacturing method of claim 10, wherein manufacturing the porous ceramic substrate comprises:
manufacturing a raw material for forming the porous ceramic substrate into a first casting slurry; and
manufacturing the porous ceramic substrate through a casting process, a thickness of the porous ceramic substrate being 1 mm to 4 mm.

12. The manufacturing method of claim 10, wherein manufacturing the ceramic covering layer comprises:
manufacturing a raw material for forming the ceramic covering layer into a second casting slurry, a powder size of the material for forming the ceramic covering layer being 0.1 μm to 5 μm; and
manufacturing the ceramic covering layer through a casting process or a dry pressing process, a thickness of the ceramic covering layer being 0.05 mm to 0.2 mm.

13. The manufacturing method of claim 10, wherein t stacking the porous ceramic substrate and the ceramic covering layer to form the integral structure comprises:
connecting the porous ceramic substrate to the ceramic covering layer through bonding or sintering.

14. The manufacturing method of claim 10, wherein forming the heating film on the surface of the ceramic covering layer away from the porous ceramic substrate comprises:
forming the heating film on the surface of the ceramic covering layer away from the porous ceramic substrate through physical vapor deposition, chemical vapor deposition, electroplating, electrodeposition, ion plating, or coating, a thickness of the heating film being 2 μm to 10 μm.

15. The manufacturing method of claim 10, wherein forming the heating film on the surface of the ceramic covering layer away from the porous ceramic substrate comprises:
forming a first covering film on the surface of the ceramic covering layer away from the porous ceramic substrate through physical vapor deposition, chemical vapor deposition, electroplating, electrodeposition, ion plating, or coating; and
forming a second covering film on a surface of the first covering film away from the ceramic covering layer through physical vapor deposition, chemical vapor deposition, electroplating, electrodeposition, ion plating, or coating, the first covering film and the second covering film forming the heating film.

16. The manufacturing method of claim 15, wherein the first covering film and the second covering film comprise metal or alloy.

17. An electronic vaporization device, comprising:
a liquid storage cavity configured to store e-liquid; and
the vaporization core of claim 1,
wherein e-liquid in the liquid storage cavity is transmittable to the ceramic covering layer through the porous ceramic substrate.
